(19) United States
(12) Patent Application Publication
(10) Pub. No.: US 2025/0201985 A1
(43) Pub. Date: Jun. 19, 2025

(54) POWER STORAGE DEVICE

(71) Applicant: TOYOTA JIDOSHA KABUSHIKI KAISHA, Toyota-shi (JP)

(72) Inventor: Yudai HASEGAWA, Toyota-shi (JP)

(73) Assignee: TOYOTA JIDOSHA KABUSHIKI KAISHA, Toyota-shi (JP)

(21) Appl. No.: 18/921,303

(22) Filed: Oct. 21, 2024

(30) Foreign Application Priority Data
Dec. 15, 2023 (JP) 2023-212370

(51) Int. Cl. H01M 50/184; H01G 9/04; H01G 9/10; H01M 50/103; H01M 50/186; H01M 50/636

(52) U.S. Cl. CPC H01M 50/184; H01G 9/04; H01G 9/10; H01M 50/103; H01M 50/186; H01M 50/636

(57) ABSTRACT

The power storage device includes an electrode body, a holding portion for holding an edge portion of the electrode body, a sealing portion for sealing the liquid injection port formed in the holding portion, a protective member for protecting the sealing portion, and a pair of conductive plates arranged so as to be in contact with the electrode body from both sides of the electrode body in the laminating direction. The sealing portion protrudes from the holding portion in a direction orthogonal to the stacking direction. The protective member includes: a covering portion covering the sealing portion; a first connecting portion connecting the conductive plate disposed on one side of the covering portion in the laminating direction and the covering portion; and a second connecting portion connecting the conductive plate disposed on the other side of the covering portion in the laminating direction and the covering portion.

### CROSS-REFERENCE TO RELATED APPLICATION

This application claims priority to Japanese Patent Application No. 2023-212370 filed on Dec. 15, 2023, incorporated herein by reference in its entirety.

### BACKGROUND

### 1. Technical Field

The present disclosure relates to a power storage device.

### 2. Description of Related Art

Japanese Unexamined Patent Application Publication No. 2023-80893 (JP 2023-80893 A) discloses a power storage module including a plurality of bipolar cells stacked on each other and a sealing member that seals a liquid injection port formed in the bipolar cells. A liquid injection member of each cell protrudes in a direction orthogonal to the stacking direction.

### SUMMARY

In the power storage module described in JP 2023-80893 A, there is a concern that a component making up a power storage device will come into contact with the sealing member, due to vibrations or the like. In addition, when conductive plates such as current collector plates or the like are laminated on both faces of the power storage module, there is a concern that the conductive plates will become positionally deviated from each other.

An object of the present disclosure is to provide a power storage device capable of achieving both protection of a sealing member for sealing a liquid injection port and suppression of positional deviation among conductive plates.

A power storage device according to an aspect of the present disclosure includes:
an electrode body including a plurality of electrodes laminated on each other,
a holding portion that holds an edge portion of the electrode body,
a sealing portion that seals a liquid injection port fashioned in the holding portion,
a protective member that protects the sealing portion, and
a pair of conductive plates disposed so as to be in contact with the electrode body from both sides of the electrode body in a laminating direction of the electrodes, in which
the sealing portion protrudes from the holding portion in an orthogonal direction that is orthogonal to the laminating direction, and the protective member includes a covering portion that covers the sealing portion at a distance from the sealing portion in the orthogonal direction, a first linking portion that links the conductive plate disposed on one side of the covering portion in the laminating direction, and the covering portion, and
a second linking portion that links the conductive plate disposed on another side of the covering portion in the laminating direction, and the covering portion.

According to the present disclosure, a power storage device can be provided that is capable of achieving both protection of a sealing member that seals a liquid injection port and suppression of positional deviation among conductive plates.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a part of a power storage device according to an embodiment of the present disclosure;

FIG. 2 is a perspective view of a protective member;

FIG. 3 is a cross-sectional view schematically showing a power storage device;

FIG. 4 is a perspective view schematically showing a modification of the power storage module; and

FIG. 5 is a cross-sectional view schematically illustrating a modification of the power storage device.

### DETAILED DESCRIPTION OF EMBODIMENTS

Embodiments of the present disclosure will be described with reference to the drawings. In the drawings referred to below, the same or corresponding members are denoted by the same reference numerals.

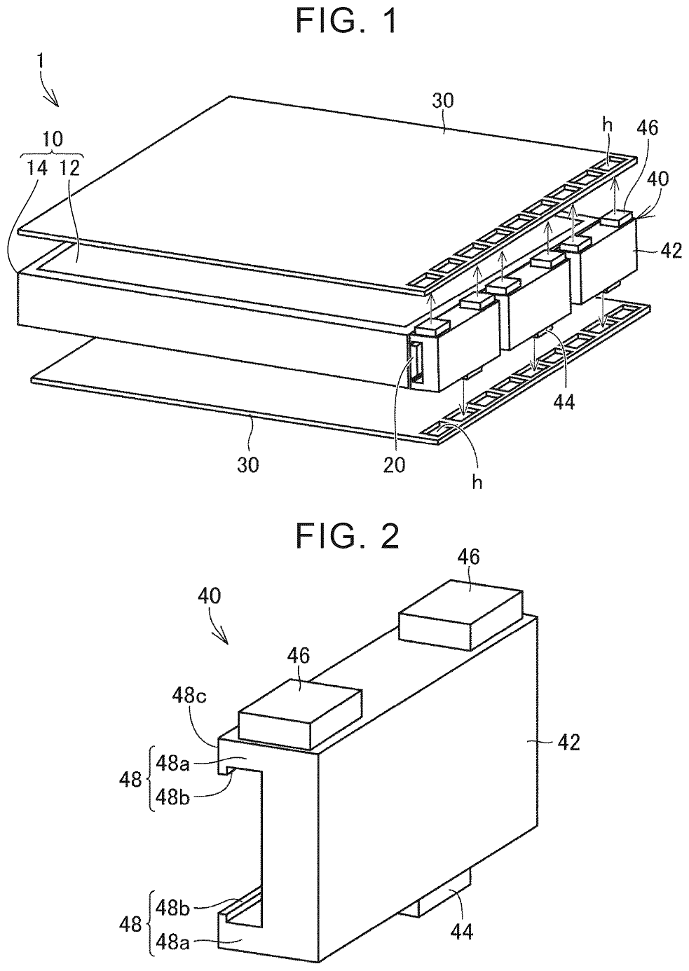

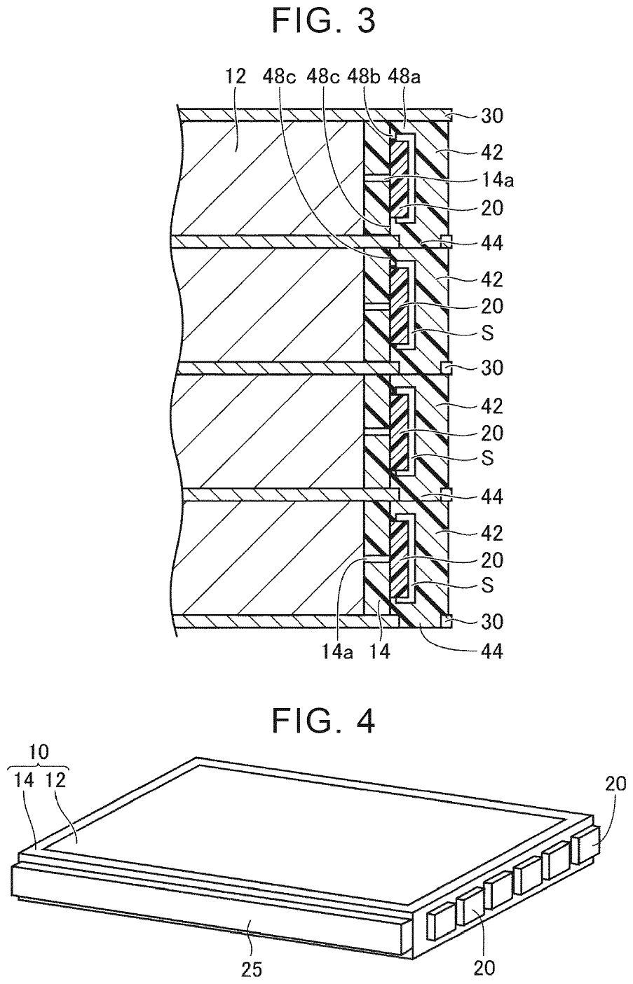

FIG. 1 is a perspective view schematically illustrating a part of a power storage device according to an embodiment of the present disclosure. FIG. 2 is a perspective view of a protective member. FIG. 3 is a cross-sectional view schematically showing a power storage device.

As illustrated in FIGS. 1 to 3, the power storage device 1 includes at least one power storage module 10, a sealing portion 20, a pair of conductive plates 30, and a protective member 40.

The at least one power storage module 10 includes a plurality of power storage modules 10. In the present embodiment, as shown in FIG. 3, the power storage device 1 includes four power storage modules 10. However, the number of the power storage modules 10 is not limited to four. The power storage module 10 includes an electrode body 12 and a holding portion 14.

The electrode body 12 includes a plurality of electrodes (not shown) stacked on each other and a plurality of separators (not shown). An outer shape of the electrode body 12 in a plan view is formed in a rectangular shape. The plurality of electrodes includes a terminal electrode disposed on the outermost side in the stacking direction of the plurality of electrodes, and a plurality of bipolar electrodes disposed between the terminal electrodes. However, each electrode may be formed of a monopolar electrode (not shown).

The holding portion 14 holds an edge portion of the electrode body 12. The holding portion 14 is formed in a rectangular cylindrical shape surrounding the periphery of the electrode body 12. The holding portion 14 is made of an insulating material. The holding portion 14 is preferably made of a synthetic resin (polyethylene, polypropylene, or the like). The holding portion 14 seals an edge portion of the electrode body 12. The holding portion 14 has a function of suppressing leakage of the electrolyte from the electrode body 12 and intrusion of moisture from the outside into the electrode body 12, and a function of securing an interval between the electrodes.

As shown in FIG. 3, a plurality of liquid injection ports 14a for supplying the electrolyte to the electrode body 12 are formed in the holding portion 14. The plurality of liquid injection ports 14a are spaced apart from each other in a longitudinal direction of one of the four side portions of the holding portion 14 (a direction perpendicular to the plane of the drawing in FIG. 3).

The sealing portion 20 seals the liquid injection port 14a. The sealing portion 20 protrudes from the holding portion 14 in a direction orthogonal to the stacking direction. The outer shape of the sealing portion 20 is formed in a substantially rectangular parallelepiped shape.

The pair of conductive plates 30 are arranged so as to be in contact with the electrode body 12 from both sides of the electrode body 12 in the laminating direction. In the present embodiment, each conductive plate 30 is also in contact with the holding portion 14. That is, the pair of conductive plates 30 are in contact with the power storage module 10 from both sides of the power storage module 10 in the stacking direction. Each conductive plate 30 is formed in a flat plate shape. As shown in FIG. 1, each conductive plate 30 has a plurality of through holes h.

The conductive plate 30 is formed of a cooling plate or a current collector plate. The cooling plate cools the power storage module 10 by a refrigerant (water, air, or the like) flowing in the cooling plate. The conductive plate 30 disposed on the outermost side (the lowermost surface and the uppermost surface) in the stacking direction is constituted by a current collector plate in contact with the terminal electrode of the electrode body 12. For example, the conductive plate 30 disposed between the power storage module 10 disposed on the lowermost side and the power storage module 10 stacked on the lowermost side, and the conductive plate 30 disposed between the power storage module 10 disposed on the uppermost side and the power storage module 10 adjacent to the lowermost side may be formed of a cooling plate. The conductive plate 30 disposed between the power storage module 10 disposed second from the bottom and the power storage module 10 disposed second from the top may be formed of a current collector plate.

The protective member 40 protects the sealing portion 20. The protective member 40 is preferably made of a synthetic resin having electrolyte resistance. The protective member 40 includes a covering portion 42, a first connecting portion 44, a second connecting portion 46, and a pair of clamping portions 48.

The covering portion 42 covers the sealing portion 20 at a distance from the sealing portion 20 in the orthogonal direction. That is, as shown in FIG. 3, a space S is formed between the outer surface of the sealing portion 20 and the covering portion 42. The covering portion 42 is formed in a flat plate shape. As shown in FIG. 3, the length of the covering portion 42 in the laminating direction is the same as the length of the electrode body 12 in the laminating direction.

The first connecting portion 44 connects the conductive plate 30 and the covering portion 42 disposed on one side (for example, the lower side) of the covering portion 42 in the laminating direction. The first connecting portion 44 protrudes from the covering portion 42 toward one side in the laminating direction. As shown in FIG. 2, the first connecting portion 44 protrudes from a central portion of the covering portion 42 in a direction orthogonal to both the thickness direction and the up-down direction of the covering portion 42.

The second connecting portion 46 connects the conductive plate 30 and the covering portion 42 disposed on the other side (for example, the upper side) of the covering portion 42 in the laminating direction. The second connecting portion 46 protrudes from the covering portion 42 toward the other side in the laminating direction. As shown in FIG. 2, the second connecting portion 46 protrudes from both end portions of the covering portion 42 in a direction orthogonal to both the thickness direction and the up-down direction of the covering portion 42. The second connecting portion 46 is provided at a position not overlapping with the first connecting portion 44 in the up-down direction.

Each through hole h formed in the conductive plate 30 has a shape for receiving each of the first connecting portion 44 and the second connecting portion 46. The first connecting portion 44 and the second connecting portion 46 are inserted into the respective through holes h. As shown in FIG. 3, the length of the first connecting portion 44 in the stacking direction is the same as the thickness of the conductive plate 30. Further, the length of the second connecting portion 46 in the stacking direction is the same as the thickness of the conductive plate 30.

The pair of clamping portions 48 clamp the sealing portions 20 from both sides in the stacking direction. Each of the clamping portions 48 has an arm portion 48a and a holding portion 48b.

The arm portion 48a extends from the inner surface of the covering portion 42 toward the power storage module 10. The length of the arm portion 48a in the orthogonal direction is larger than the length of the sealing portion 20 in the orthogonal direction. The arm portion 48a includes an abutting portion 48c that abuts against the sealing portion 20. The abutting portion 48c is formed by an inner end surface of the arm portion 48a in the perpendicular direction. The abutting portion 48c is formed flat.

The holding portion 48b protrudes from the inner end portion of the arm portion 48a in the perpendicular direction toward the sealing portion 20. The holding portion 48b is in contact with the end surface of the sealing portion 20 in the laminating direction. The holding portion 48b extends in a direction perpendicular to both the thickness direction and the up-down direction of the covering portion 42. The length between the pair of holding portion 48b in the stacking direction is set to be slightly smaller than the length of the sealing portion 20 in the stacking direction. That is, the sealing portion 20 is press-fitted between the pair of holding portions 48b.

Next, an example of a method of manufacturing the power storage device 1 will be described. For example, the first conductive plate 30 is placed on a flat placing table, and the protective member 40 is attached to each sealing portion 20. Then, the first connecting portion 44 of the protective member 40 is inserted into the through hole h of the first conductive plate 30. Next, the second conductive plate 30 is stacked on the power storage module 10 so that the second connecting portion 46 of each protective member 40 is inserted into the through hole h of the second conductive plate 30. By repeating the above steps, the power storage device 1 is manufactured.

As described above, in the power storage device 1 according to the present embodiment, the covering portion 42 covers the sealing portion 20 at a distance from the sealing portion 20. Therefore, even when a load is input from the outside to the covering portion 42, the sealing portion 20 is effectively protected, and the pair of conductive plates 30 are connected to each other by the connecting portions 44 and 46. Therefore, misalignment between the conductive plates 30 is suppressed.

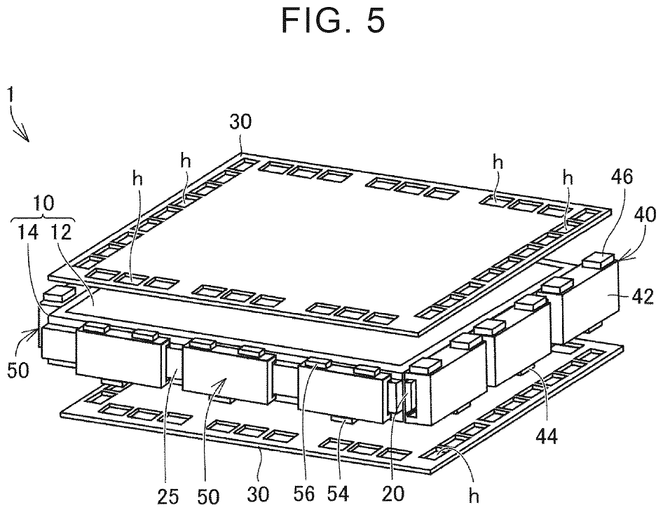

As illustrated in FIGS. 4 and 5, the power storage device 1 may further include a rail portion 25 provided on each side portion of the holding portion 14 where the liquid injection ports 14a are not formed, and a plurality of connecting members 50 that can be attached to each rail portion 25. The rail portion 25 has a shape extending along the longitudinal direction of the side portion on which the rail portion 25 is provided. The configuration of the connecting member 50 corresponds to the configuration of the protective member 40. The conductive plate 30 has a through hole h for receiving the first connecting portion 54 and the second connecting portion 56 of each connecting member 50.

It will be understood by those skilled in the art that the exemplary embodiments and examples described above are illustrative of the following aspects.

### First Aspect

An electrode body including a plurality of electrodes laminated on each other,
a holding portion that holds an edge portion of the electrode body,
a sealing portion that seals a liquid injection port fashioned in the holding portion,
a protective member that protects the sealing portion, and
a pair of conductive plates disposed so as to be in contact with the electrode body from both sides of the electrode body in a laminating direction of the electrodes, in which
the sealing portion protrudes from the holding portion in an orthogonal direction that is orthogonal to the laminating direction, and
the protective member includes
a covering portion that covers the sealing portion at a distance from the sealing portion in the orthogonal direction,
a first linking portion that links the conductive plate disposed on one side of the covering portion in the laminating direction, and the covering portion, and
A power storage device comprising: a second connecting portion that connects the conductive plate and the covering portion disposed on the other side of the covering portion in the stacking direction.

In this power storage device, the covering portion covers the sealing portion at a distance from the sealing portion. Therefore, even when a load is input to the covering portion from the outside, the sealing portion is effectively protected, and the pair of conductive plates are connected to each other by the respective connecting portions. Therefore, misalignment between the conductive plates is suppressed.

### Second Aspect

The power storage device according to the first aspect, wherein the protective member further includes a pair of clamping portions for clamping the sealing portions from both sides in the stacking direction.

In this aspect, the relative displacement of the electrode body with respect to each conductive plate is suppressed.

### Third Aspect

The power storage device according to the second aspect, wherein each of the pair of clamping portion includes an abutting portion that abuts against the holding portion.

In this aspect, when a load is input in a direction from the protective member toward the electrode body, each of the clamping portions supports the load between the holding portion and the covering portion, so that the covering portion contacts the sealing portion and damage to the sealing portion caused thereby is effectively suppressed.

### Fourth Aspect

The power storage device according to the first aspect, wherein a length of the covering portion in the laminating direction is the same as a length of the electrode body in the laminating direction.

In this aspect, a load in the laminating direction acting on an outer portion of the electrode body in a direction orthogonal to the laminating direction of the conductive plate can be received by the covering portion.

### Fifth Aspect

Each conductive plate has a through hole for receiving the first connecting portion and the second connecting portion,
The power storage device according to the fourth aspect, wherein a length of the first connecting portion in the stacking direction and a length of the second connecting portion in the stacking direction are the same as a thickness of each of the conductive plates.

In this aspect, since the sum of the thicknesses of the electrode body and the pair of conductive plates is the same as the sum of the lengths of the connecting portions and the covering portions in the laminating direction, the lamination of the plurality of electrode bodies and the conductive plates is facilitated.

It should be understood that the embodiments disclosed herein are illustrative and non-restrictive in all respects. The scope of the present disclosure is defined by the terms of the claims, rather than the description of the embodiments described above, and includes all modifications within the scope and meaning equivalent to the terms of the claims.

What is claimed is:

1. A power storage device, comprising:
an electrode body including a plurality of electrodes laminated on each other;
a holding portion that holds an edge portion of the electrode body;
a sealing portion that seals a liquid injection port fashioned in the holding portion;
a protective member that protects the sealing portion; and
a pair of conductive plates disposed so as to be in contact with the electrode body from both sides of the electrode body in a laminating direction of the electrodes, wherein
the sealing portion protrudes from the holding portion in an orthogonal direction that is orthogonal to the laminating direction, and
the protective member includes
a covering portion that covers the sealing portion at a distance from the sealing portion in the orthogonal direction,
a first linking portion that links the conductive plate disposed on one side of the covering portion in the laminating direction, and the covering portion, and
a second linking portion that links the conductive plate disposed on another side of the covering portion in the laminating direction, and the covering portion.

2. The power storage device according to claim 1, wherein the protective member further includes a pair of clamping portions that clamps the sealing portion from both sides in the laminating direction.

3. The power storage device according to claim 2, wherein each of the clamping portions includes an abutting portion that abuts against the holding portion.

4. The power storage device according to claim 1, wherein a length of the covering portion in the laminating direction is the same as a length of the electrode body in the laminating direction.

5. The power storage device according to claim 4, wherein:
each of the conductive plates includes a through hole that receives the first linking portion and the second linking portion; and
a length of the first linking portion in the laminating direction and a length of the second linking portion in the laminating direction are the same as a thickness of each conductive plate.
